(19) United States
(12) Patent Application Publication
(10) Pub. No.: US 2010/0189524 A1
(43) Pub. Date: Jul. 29, 2010

(54) Dust-disposal mechanism for machine tool

(75) Inventor: Shiau-Wei Yin, Taiping City (TW)

Correspondence Address: CHARLES E. BAXLEY, ESQUIRE, 90 JOHN STREET, SUITE 309, NEW YORK, NY, 10038, US

(73) Assignee: IDI Precision Machinery Ltd.

(21) Appl. No.: 12/321,873

(22) Filed: Jan. 27, 2009

(51) Int. Cl. B23Q 11/00

(52) U.S. Cl. 409/137

(57) ABSTRACT

A dust-disposal mechanism applied to a machine tool implements a dust-extraction device to efficiently remove cutting dust in a cutting area of the machine tool and prevent cutting dust from floating around in the air.

### BACKGROUND OF THE INVENTION

1. Technical Field

The present invention relates to machine tools, and more particularly, to a dust-disposal mechanism applied to a machine tool for preventing cutting dust from floating around in the air.

2. Description of Related Art

It is known that some materials, such as graphite, wood, composite materials, ceramics and so on, when being machined by a machine tool, tend to generate considerable quantities of cutting dust that is of very fine and very rigid particles. If the machine tool is not equipped with a competent dust-disposal mechanism, such cutting dust can intrude into the machine tool and may damage machine parts or break circuits in the machine tool.

One conventional dust-proof approach refers to employing a round water curtain that surrounds the cutting area of the machine tool so that cutting dust of the machine tool can be enclosed by the water curtain from escaping outward and distributing over the air. Then the water flowing from the water curtain and containing the cutting dust is collected, filtered and reused. The conventional dust-proof approach however has some defects.

First, if the water flow is not properly controlled, it may be too strong and damage the workpiece.

Second, the cutting dust will deposit in the water tank and is difficult to clean.

Third, this conventional dust-proof approach is inapplicable when the workpiece must be kept dry (such as graphite parts used in semi-conductor manufacturing process).

An alternative dust-proof solution is dry dust collection. As shown in FIG. 1, a dust-collection pipe 80 is provided beside and moves simultaneously with the spindle of the machine tool. Cutting dust of the workpiece machined by the machine tool thus is collected by the dust-collection pipe 80 and is then filtered in a filtering system. Nevertheless, such dry dust collection suffers from some drawbacks.

Because the dust-collection pipe can not touch the workpiece neither can it causes any obstruction to the automatic tool change process of the machine tool, the dust-collection pipe and its air inlet must remain distant from the spindle and cutting point, resulting in limited dust collecting effect.

Second, when a long cutting tool is used, the air inlet of the dust-collection pipe is even further from the cutting point, causing the dust collecting effect further inferior.

Third, since the cutting area is an open space while air flows faster at a location near the air inlet and flows slower at a location far from the air inlet, the cutting dust far from the air inlet can less or can even not be effectively collected and may then distribute over the open space.

One more conventional dust-proof solution is to use a dust-collection chamber. As can be seen in FIG. 2, a dust-collection chamber 81 is installed in the cutting area of a machine tool. The dust-collection chamber 81 has an opening 82 so that a workpiece to be cut can be placed into the dust-collection chamber 81 while a dust-collection pipe 83 is installed on a wall of the dust-collection chamber. Such dust-collection chamber is yet disadvantageous by some reasons.

First, the opening allows cutting dust of the workpiece to escape therefrom and distribute over the air.

Second, since air flows faster at a location near the air inlet and flows slower at a location far from the air inlet, the cutting dust far from the air inlet can be less or even not collected, resulting in inferior dust collecting effect.

Third, when the workpiece is so high that a cutting point thereof is higher than the air inlet, the cutting dust tends to escape from the opening, causing the dust collecting effect incompetent.

### SUMMARY OF THE INVENTION

One primary objective of the present invention is to provide a dust-disposal mechanism for a machine tool. The dust-disposal mechanism serves to collect cutting dust in a cutting area of the machine tool and implements a dust-extraction device to efficiently remove the cutting dust from the cutting area, thereby preventing the cutting dust from escaping from the dust-disposal mechanism.

To achieve the objective of the present invention, the dust-disposal mechanism comprises:

a dust-collection cover assembled to the machine tool, wherein the dust-collection cover comprises an air-filling structure located above the dust-collection cover and an air-extracting structure located below the dust-collection cover;

a dust-block board, formed with a spindle hole for allowing a spindle of the machine tool to pass therethrough, wherein the spindle hole is a lengthwise spindle hole;

a shielding member, settled against an upper edge of the dust-block cover; and

a dust-collection chamber, settled around a cutting area of the machine tool.

The air-extracting structure located below the dust-collection cover is a dust-extraction device that is connected with the dust-collection chamber for extracting cutting dust from the cutting area.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic drawing illustrating a device based on a conventional dry dust collection solution;

FIG. 2 is a schematic drawing illustrating a device based on a conventional dust-collection chamber solution;

FIG. 3 is a schematic drawing showing the configuration of a dust-block board of the present invention;

FIG. 4 is a schematic drawing showing the configuration of a dust-disposal mechanism of the present invention;

FIG. 5 is a cross-sectional view of the dust-disposal mechanism taken along Line 5-5 of FIG. 4 showing paths of air flow thereabout;

FIG. 6 is another cross-sectional view of the dust-disposal mechanism taken along Line 5-5 of FIG. 4 showing a shielding member added and paths of air flow thereabout;

FIG. 7 is a schematic drawing showing the dust-disposal mechanism wherein a sliding door of the dust-block cover is closed;

FIG. 8 is a schematic drawing showing the dust-disposal mechanism wherein the sliding door of the dust-block cover is opened;

FIG. 9 is a schematic drawing showing the dust-disposal mechanism of the present invention applied to a machine tool having a shiftable spindle;

FIG. 10 is an enlarged view of the circle at the right part of FIG. 5; and

FIG. 11 is an enlarged view of the circle at the left part of FIG. 5.

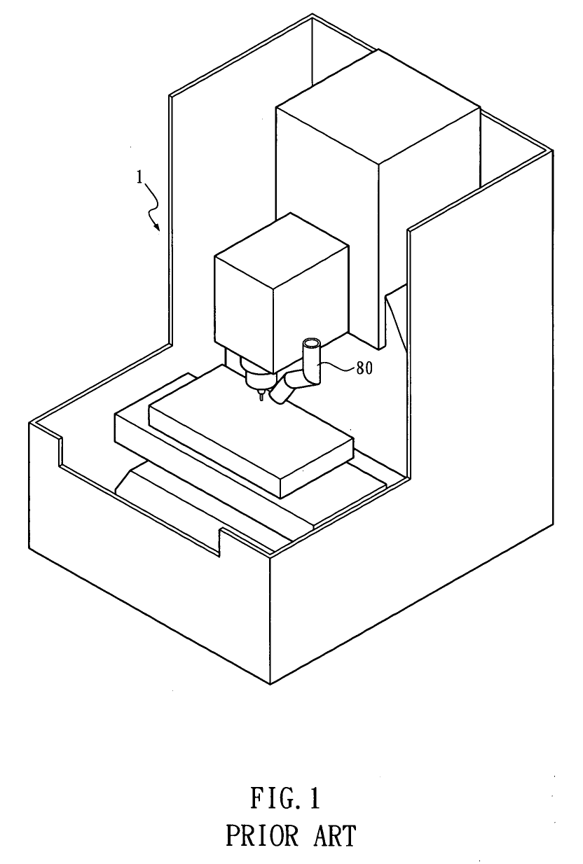

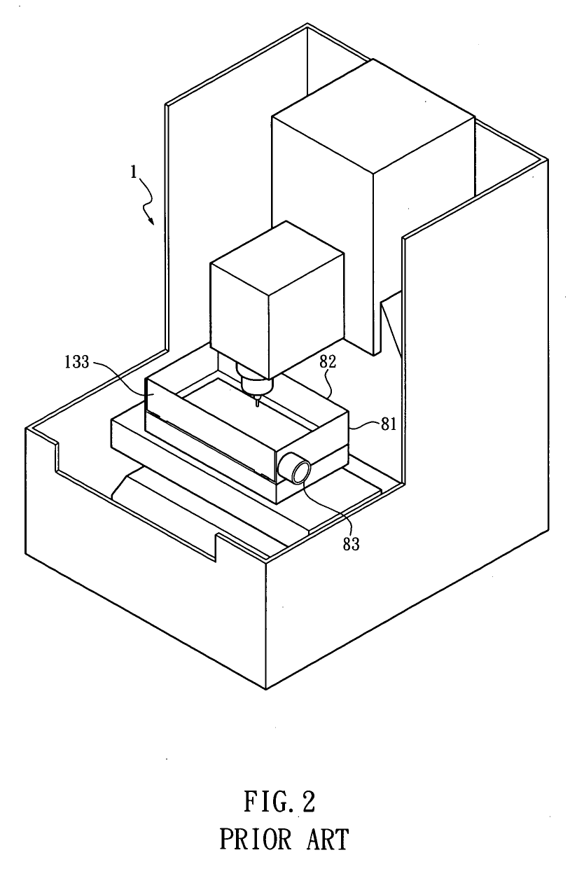

### DETAILED DESCRIPTION OF THE PREFERRED EMBODIMENTS

While a preferred embodiment is provided herein for illustrating the concept of the present invention as described above, it is to be understood that the components in these drawings are made for better explanation and need not to be made in scale. Moreover, in the following description, resemble components are indicated by the same numerals.

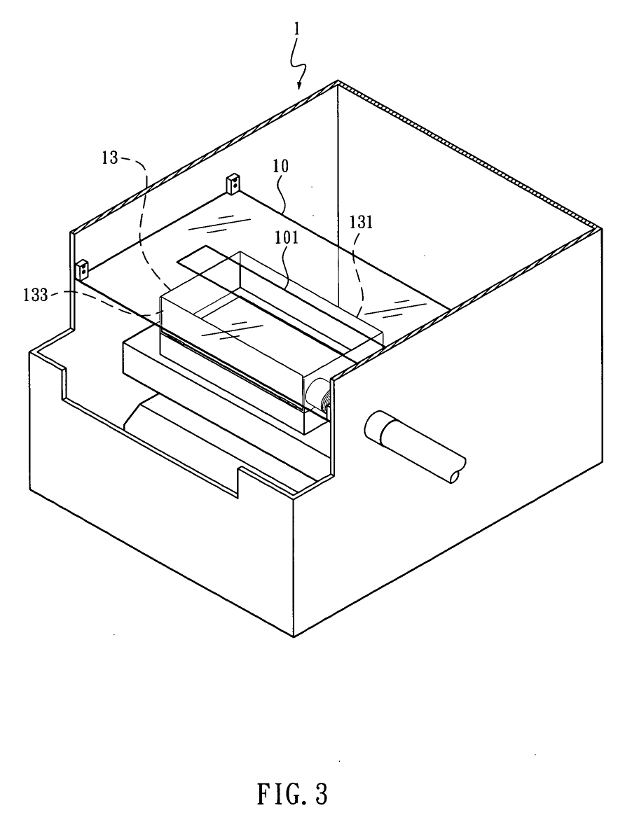

Please refer to FIGS. 3 through 5 for a dust-disposal mechanism according to the present invention. The dust-disposal mechanism comprises a dust-collection cover 3 assembled to a machine tool 1. The dust-collection cover 3 is equipped with an air-filling structure located above the dust-collection cover 3 and an air-extracting structure located below the dust-collection cover 3. The dust-collection cover 3 further comprises a dust-block board 10 formed with a spindle hole 101 for allowing a spindle 21 of the machine tool 1 to freely pass therethrough, wherein the spindle hole 101 is a lengthwise spindle hole. The dust-block board 10 is fixed to the machine tool 1 and there is a dust-block cover 11 immovably attached onto a top of the dust-block board 10 for encircling the spindle hole 101 so as to prevent cutting dust from escaping outward through the spindle hole 101. An outer shield 12 including a shielding member 121 and at least two lateral walls 122 has the shielding member 121 settled upon an upper edge of the dust-block cover 11 with a ventilation gap 111 provided therebetween for ventilation while the two lateral walls 122 are connected with the shielding member 121. The air-filling structure located above the dust-collection cover 3 refers to the ventilation gap 111 provided between the upper edge of the dust-block cover 11 and the bottom of the shielding member 121. A dust-collection chamber 13 is settled around a cutting area of a machine tool 1 and below the dust-block board 10. The dust-collection chamber 13 has an upward opening 131. The air-extracting structure located below the dust-collection cover 3 is a dust-extraction device 132 that is connected with the dust-collection chamber 13 for extracting cutting dust from the cutting area. The dust-collection chamber 13 further has a front-opened board 133 to be opened for facilitating calibration of the origin of the workpiece.

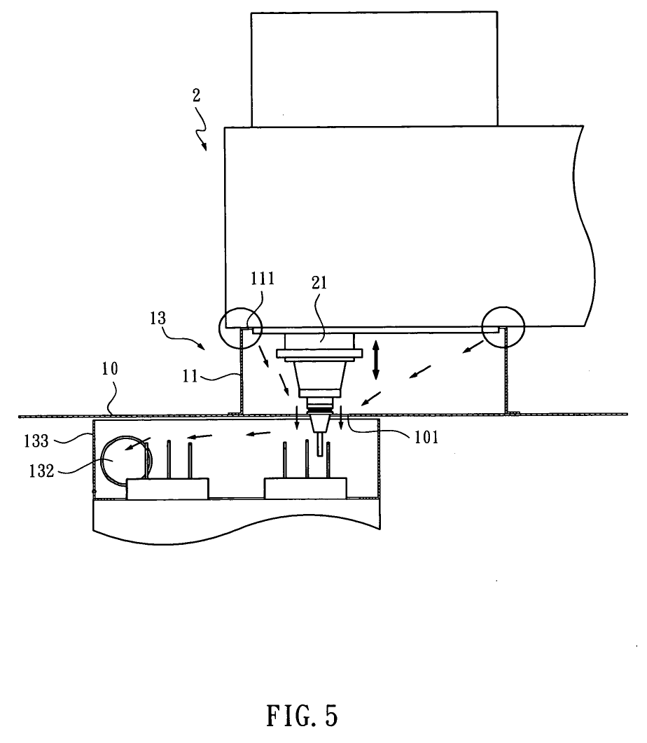

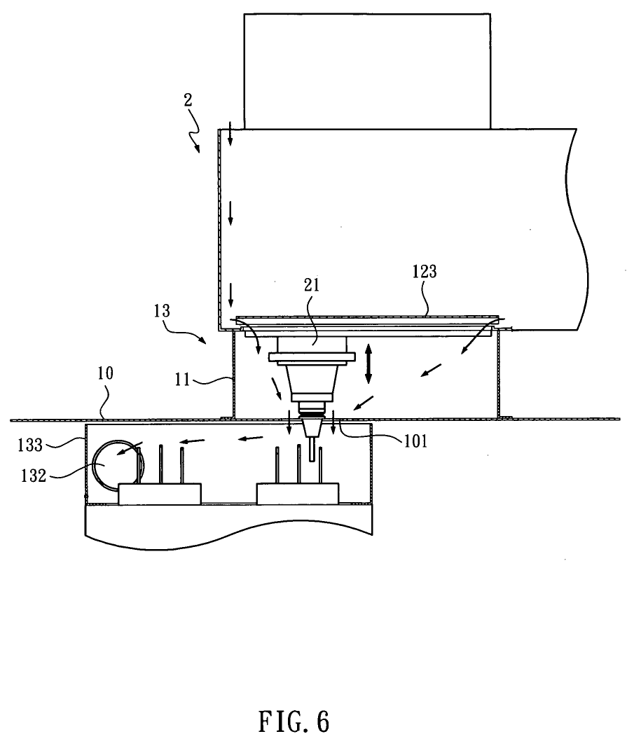

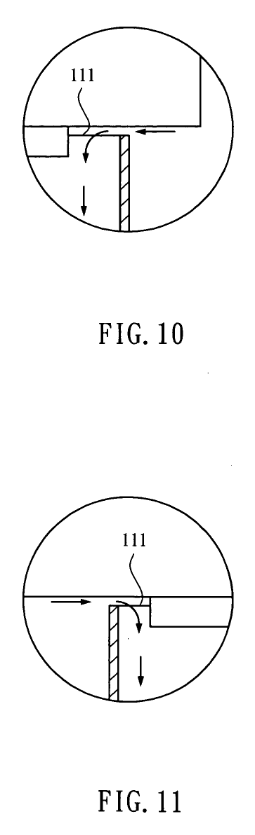

Referring to FIGS. 5, 6, 10 and 11, the dust-extraction device 132 draws air into the dust-block cover 11 through the ventilation gap 111 at the upper edge of the dust-block cover 11. As there is no direct air-communicable channel except the ventilation gap 111 between the dust-extraction device 132 and the exterior of the dust-block cover 11, according to Bernoulli's Equation, which states that, for an air flow, an increase in the speed of the fluid occurs simultaneously with a decrease in pressure or a decrease in the fluid's potential energy, pressure in the dust-collection chamber 13 remains lower than pressure of the exterior and thus external air keeps running inward the dust-block cover 11, along paths as shown clearly by the arrows in FIG. 5. This phenomenon can efficiently prevent dust from escaping out and facilitate collect dust to the dust-extraction device 132 for later removal and thus the subject matter of the present intention presents a significantly improved dust collecting effect. Even if the dust-block cover 11 and the shielding member 121 are closely combined, namely no ventilation gap 111, through tiny gaps between the shielding member 121 and an extendable covering sheet 123 covering the shielding member 121, air can be also drawn toward the dust-extraction device 132 so that the excellent dust collecting effect can be still achieved according to according to Bernoulli's Equation.

The dust-extraction device 132 is installed at an inner lateral wall of the dust-collection chamber 13 receiving therein a dust-collection machine. The dust-collection machine may be a vacuum device or a draining device. In a case where the vacuum device is a the dust-extraction machine, the dust-extraction device 132 serves to extract the cutting dust in the dust-collection chamber 13, while in a case where the draining device is a the dust-displacement machine, a water curtain as described in the paragraph of the prior arts is implemented so that water in the dust-collection chamber 13 and dust in the water can be drained through the dust-extraction device 132.

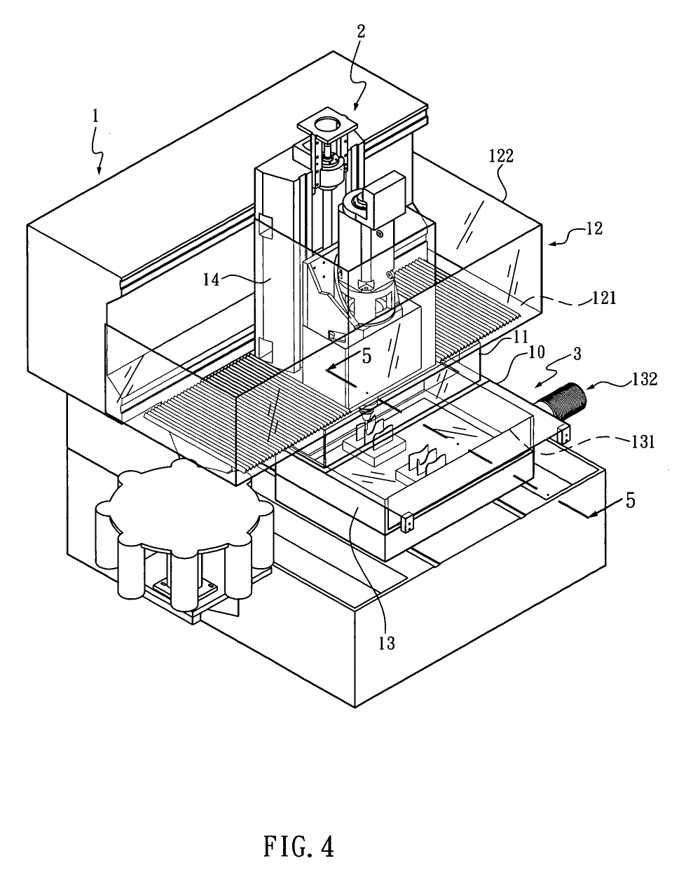

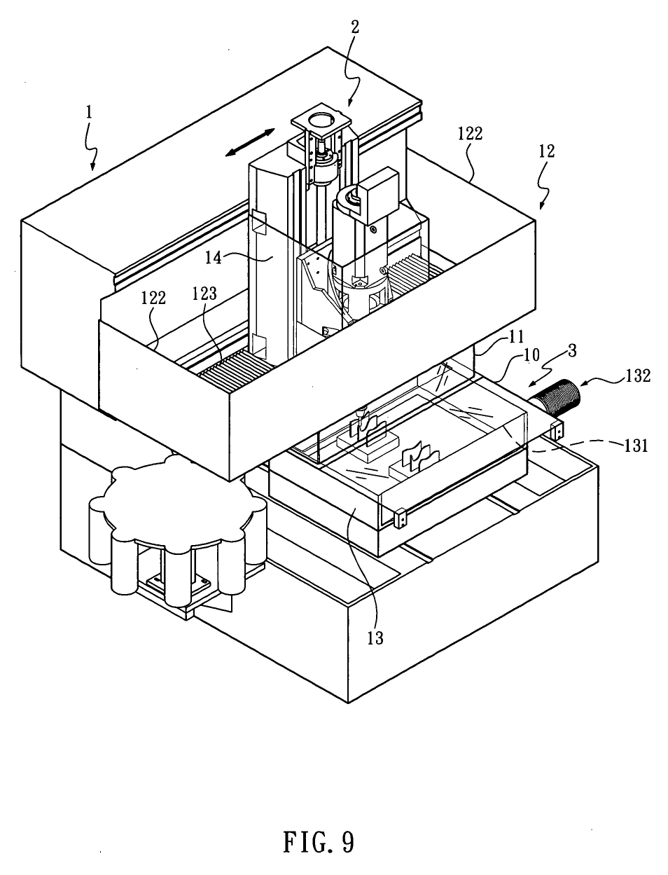

Referring to FIGS. 4 and 9, the shielding member 121 of the outer shield 12 has one side fixed to an immovable part of the machine tool 1 while the lateral walls 122 of the outer shield 12 each has one side fixed to an immovable part of the machine tool 1, wherein lower edges of the lateral walls 122 of the outer shield 12 are connected with the shielding member 121. At least one said extendable covering sheet 123 covers the shielding member 121 of the outer shield 12 and the extendable covering sheet 123 is expandable and slidable along the shielding member 121. In the present embodiment, two said extendable covering sheets 123 are implemented. The outer shield 12 encloses an inner shield 14 that is settled between the two extendable covering sheets 123. The inner shield 14 has two sides thereof fixedly connected with the extendable covering sheets 123 and another side connected with a sliding guide 2 that is capable of freely sliding horizontally. When the sliding guide 2 drives the inner shield 14 to move, the extendable covering sheets 123 moves accordingly by expanding or retracting so as to hinder cutting dust in the dust-block cover 11 from coming upward and damaging mechanical components of the machine tool 1.

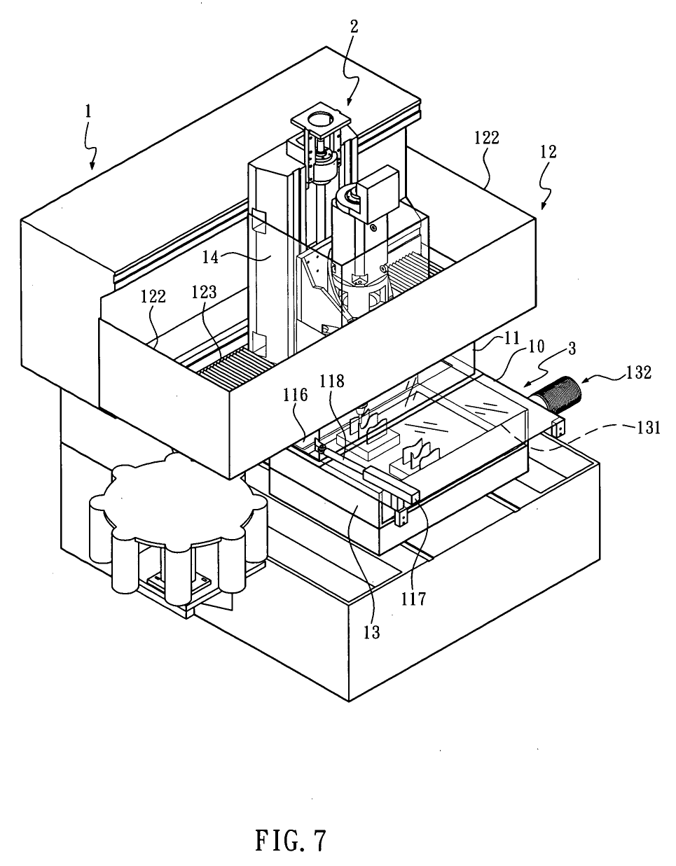

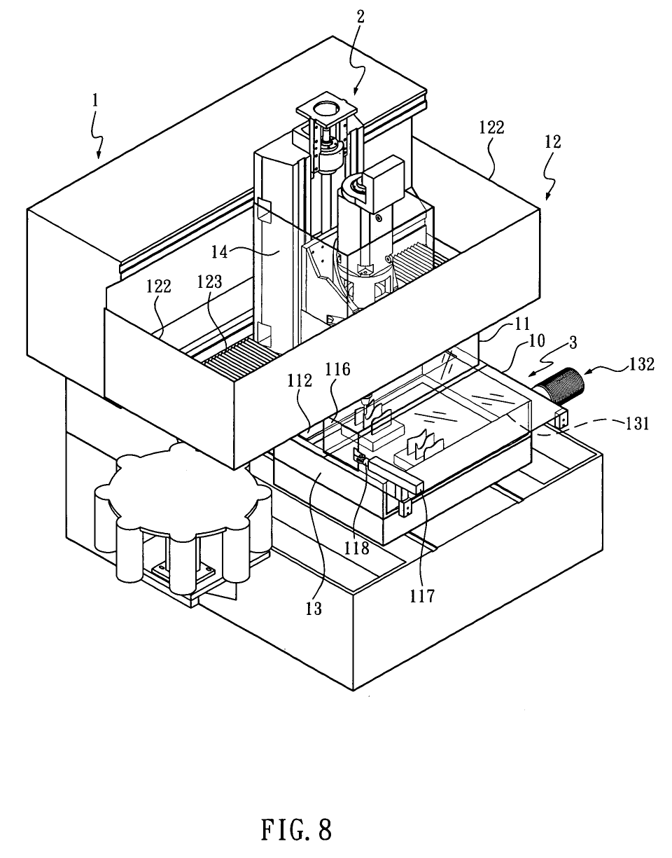

Referring to FIGS. 7 and 9, a sliding door 116 is provided at an opening 112 of the dust-block cover 11. The sliding door 116 is slidable along upper and lower edges of the dust-block cover 11. A power cylinder 117 settled at the top of the dust-block cover 11 has a driving shaft 118 connected with the sliding door 116. When the power cylinder 117 is powered, the driving shaft 118 is moved to drive the sliding door 116 to slide, and thus make the opening 112 open or close. When the sliding door 116 slides away from the opening 112, a tool-changing process can be conducted to the spindle 21 for changing the tool thereon.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A dust-disposal mechanism being applied to a machine tool, the dust-disposal mechanism comprising:
a dust-collection cover assembled to the machine tool, wherein the dust-collection cover is equipped with an air-filling structure located above the dust-collection cover and an air-extracting structure located below the dust-collection cover.

2. The dust-disposal mechanism of claim 1, wherein the dust-collection cover comprises a dust-block board formed with a spindle hole for allowing a spindle of the machine tool to pass therethrough, wherein the spindle hole is a lengthwise spindle hole.

3. The dust-disposal mechanism of claim 1, wherein a shielding member is settled upon an upper edge of the dust-block cover.

4. The dust-disposal mechanism of claim 3, wherein a dust-collection chamber is settled around a cutting area of the machine tool.

5. The dust-disposal mechanism of claim 4, wherein the air-extracting structure located below the dust-collection cover is a dust-extraction device that is connected with the dust-collection chamber for extracting cutting dust from the cutting area.

6. The dust-disposal mechanism of claim 5, wherein at least one extendable covering sheet covers the shielding member and the extendable covering sheet is slidable along the shielding member.

7. The dust-disposal mechanism of claim 6, wherein the air-filling structure located above the dust-collection cover is a ventilation gap formed between an upper edge of the dust-block cover and a lower edge of the shielding member.

8. The dust-disposal mechanism of claim 6, wherein an upper edge of the dust-block cover and a lower edge of the shielding member are closely combined.

9. The dust-disposal mechanism of claim 8, wherein, the air-filling structure located above the dust-collection cover comprises tiny gaps between the shielding member and the extendable covering sheet covering the shielding member.

10. The dust-disposal mechanism of claim 5, wherein, an opening is provided at a lateral wall of the dust-block cover and the opening is covered by a movable cover.

11. The dust-disposal mechanism of claim 5, wherein, a sliding door is provided at an opening of the dust-block cover and the sliding door is slidable along upper an lower edges of the dust-block cover.

12. The dust-disposal mechanism of claim 13, wherein, a power cylinder settled at a top of the dust-block cover has a driving shaft connected with the sliding door and when the power cylinder is powered, the driving shaft is moved to drive the sliding door to slide, so as to make the opening open or close.
